(19) United States
(12) Patent Application Publication
(10) Pub. No.: US 2004/0217048 A1
(43) Pub. Date: Nov. 4, 2004

(54) LARGE DIAMETER FILTER HOUSING WITH FLAT COVER AND BOTTOM AND METHOD OF MANUFACTURE

(75) Inventor: Richard D. Kirsgalvis, Michigan City, IN (US)

Correspondence Address: BABCOCK IP LLC, 24154 LAKESIDE DRIVE, LAKE ZURICH, IL, 60047, US

(73) Assignee: MICRON TECHNOLOGIES CORPORATION, Michigan City, IN (US)

(21) Appl. No.: 10/249,697

(22) Filed: Apr. 30, 2003

(51) Int. Cl. B01D 27/00

(52) U.S. Cl. 210/435

(57) ABSTRACT

A liquid filter housing formed by an enclosure having a sidewall, a bottom and an open top. The bottom is formed from a support structure coupled to a flat plate. The cover may also be formed from a support structure coupled to a flat plate. A support member may be located between the bottom and a mounting surface. The enclosure has an inlet and an outlet communicating with an interior of the enclosure. The inlet and the outlet may be mounted to the bottom and a feed pipe used to direct the inlet flow proximate to an upper section of the enclosure. The cover may be adapted to close the open top, for example using eyebolts.

### BACKGROUND OF INVENTION

1. Field of the Invention

The present invention generally relates to liquid filter and or strainer housings. More specifically, the present invention relates to cost efficient high throughput and or low pressure drop housings used in liquid filtration systems.

2. Description of Related Art

Filters are used in a wide range of processes, for example, removing contaminants from liquids. In general, an increase in the filter material surface area increases the operation interval before the filter material becomes unacceptably fouled. Increasing the size of filter housings increases capacity for filter material and thereby enables high throughput at low pressure differentials.

A typical liquid filter and or strainer housing utilizes a removable flat or domed cover, a cylindrical sidewall and a domed or flat bottom. The filter housing components are selected to meet specific process pressure requirements. Also, the filter housing is designed to handle vibrations that may be induced by hydraulic shocks occurring in the filter housing during process starts, stops and interruptions.

Filter housings are typically supplied with legs that raise the filter housing to enable location of process connections on the bottom and or integration with other process equipment, for example, liquid pumps with net positive suction head requirements.

In the prior filter housings the cover and bottom have typically had a flat plate or a domed configuration. If a flat plate is used, the material thickness is increased to add the strength necessary to withstand the expected process pressures. As the diameter of the filter housing is increased, using increasing flat plate thickness becomes increasingly expensive from both a raw material and manufacturing process perspective. Also, manipulating the increasing weight of a thick flat cover becomes a significant burden for the operator. Because of these limitations, filter or strainer housings with an outside diameter of 12 inches or more are typically designed with domed covers and bottoms.

The curved surfaces of a domed cover or bottom allow use of material having a thickness similar to the sidewall thickness. However, manufacture of domed covers or bottoms requires specialized equipment/processes. Domed covers or bottoms also increase the cost/complexity of connections, for example inlets, outlets, process sensors and or drains because of additional or specialized machining steps needed to adapt the connections to curved surfaces of the domed cover and or bottom. As the housing diameter is increased, costs associated with domed covers and bottoms become a significant percentage of overall housing materials and manufacturing costs.

Competition within the filter housing industry has focused attention upon minimization of materials and manufacturing costs.

Therefore, it is an object of the present invention to provide a method and apparatus that overcomes deficiencies in the prior art.

### BRIEF DESCRIPTION OF DRAWINGS

BRIEF DESCRIPTION OF THE FIGURESThe accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a cut-away side view of a first embodiment of a filter/strainer housing with a multiple filter/strainer configuration according to the invention.

FIG. 2 is a partial cut-away top view of the housing of FIG. 1.

FIG. 3 is a section bottom view along line A-A of FIG. 1.

FIG. 4 is a cut-away side view of a second embodiment of a filter/strainer housing with a multiple filter/strainer configuration according to the invention.

FIG. 5 is a bottom view of the second embodiment.

FIG. 6 is a cut-away side view of a third embodiment of a filter/strainer housing with a multiple filter/strainer configuration according to the invention.

FIG. 7 is a bottom view of the third embodiment.

FIG. 8A is a top view of a cover casting.

FIG. 8B is a side section view of the cover casting in FIG. 8A.

FIG. 9A is a top view of a collar casting.

FIG. 9B is a side section view of the collar casting in FIG. 9A.

FIG. 10A is a top view of a bottom casting.

FIG. 10B is a side section view of the bottom casting in FIG. 10A.

FIG. 11A is a partial cut-away side view of a fourth embodiment of a filter/strainer housing, bottom connections omitted for clarity.

FIG. 11B is a partial cut-away side view of a fifth embodiment of a filter/strainer housing, bottom connections omitted for clarity.

FIG. 12 is a cut-away side view of a sixth embodiment of a filter/strainer housing using a filter cartridge configuration according to the invention.

### DETAILED DESCRIPTION

The following description describes embodiments of the invention for use with a filter media that is only generically described. One skilled in the art will fully appreciate that the present invention may be practiced with a wide range of filter media, ranging, for example, from osmotic membranes to wide gap strainers.

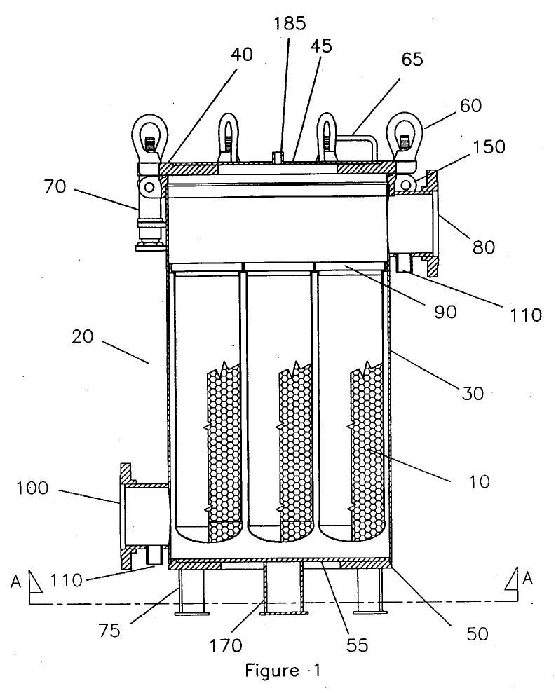

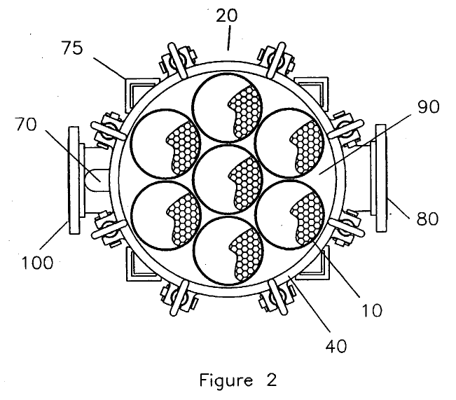

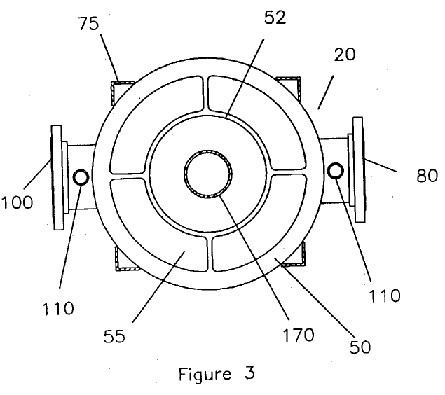

As shown in FIGS. 1-3, a first embodiment of a filter housing assembly 20 may be configured to have a plurality of filters and or filter basket(s) 10. Use of multiple filters and or filter basket(s) 10 increases the available filter media surface area. The filters and or filter basket(s) 10 are enclosed within the filter housing assembly 20 by a cylindrical filter housing sidewall 30, a cover 40 and a bottom 50.

The filter housing assembly 20 may be formed from a wide range of metals and metal alloys selected depending upon the intended process parameters and liquid to be filtered. Examples of specific materials include, for example, stainless-steel, aluminum, titanium and/or carbon steel.

The cover 40 may be configured for easy access to the interior of the filter housing assembly 20 via, for example, a cover swing handle 65, eyebolt assembly(s) 60 and a pivot assembly 70. By unscrewing the eyebolts 60 the cover 40 may be swung aside via the pivot assembly 70 allowing full access to the filter housing assembly 20 interior for exchange and or cleaning of the filters and or filter baskets 10. When the eyebolt assembly(s) 60 are secured, the cover 40 may be sealed to the filter housing assembly 20 using an o-ring or other gasket to enable operation of a sealed, pressurized process. Various process and or sensor connections may be added to the cover 40, for example, a vent port 185. A plurality of legs 75 may be added to raise the filter housing assembly 20 above desired process connections and or provide necessary net positive suction head for associated process pumps. The legs 75 may be cost efficiently formed from, for example, standard angled material with or without feet.

Process fluid flows into the filter housing assembly 20 via an inlet 80, through the filter media and filter basket(s) 10 that are supported, for example, by a basket support plate 90. Filtered process fluid then exits the filter housing through outlet 100. Drain port(s) 110 allow the filter housing assembly 20 to be drained without removing interconnecting process piping.

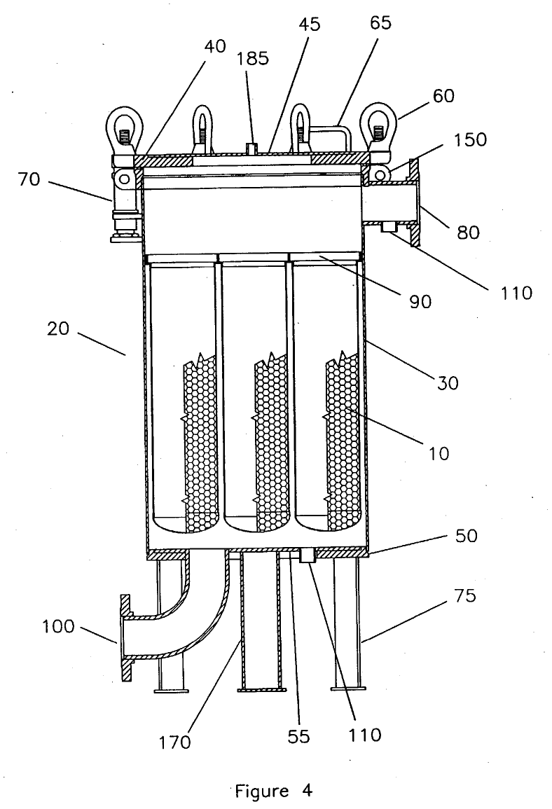

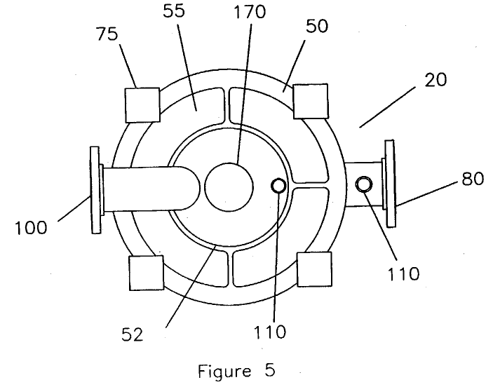

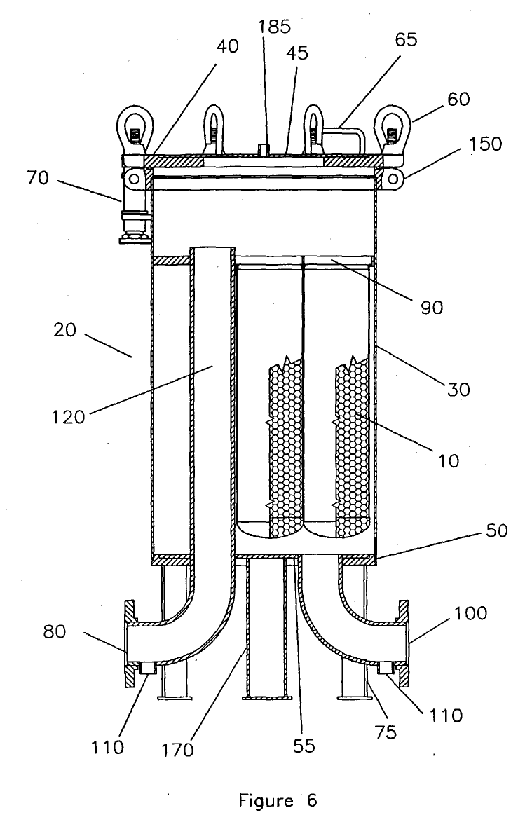

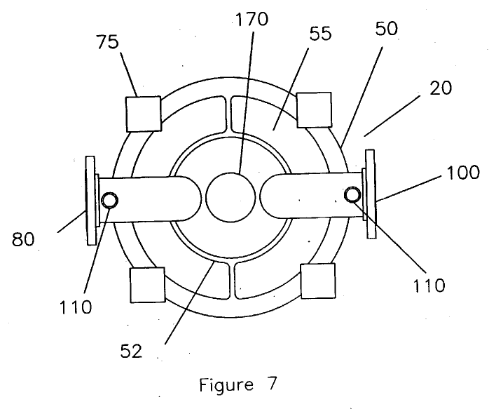

As shown, for example, by FIGS. 4-7, the inlet 80 and outlet 100 configuration may be modified to suit the intended process requirements. For example, as shown by FIG. 4, the outlet 100 may be located in the bottom 50, where a fully draining connection is made to the flat bottom 50 surface. A further advantage of the bottom 50 connection is a simplification of the machining requirements to mate the outlet 100 to a flat rather than curved surface. As shown in FIG. 6, both the inlet 80 and the outlet 100 may be bottom mounted if an inlet riser 120 is used to internally route the process flow to an input side of the filter media. In this embodiment, the inlet riser 120 routes the process flow through and above the basket support plate 90.

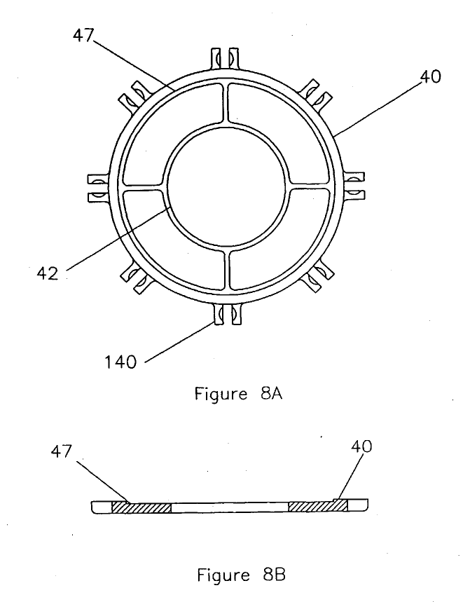

The present invention replaces the former thick flat plate and or domed cover and bottom configurations with cost efficient assemblies using cast, forged or machined components as shown in FIGS. 8A-10B.

As shown in FIGS. 8A and 8B, the cover 40 has a reinforcing cover support web 42 coupled to an outer ring. One skilled in the art will appreciate that the reinforcing cover support web 42 is provided for explanatory purposes and that a plurality of different cover support web 42 configurations are possible, each selected according to the desired connections, dimensions and process parameters required for a specific filter housing assembly 20. The selected filter housing closure may be integrated with the cover 40. For example, to accommodate eyebolt assembly(s) 60, eyebolt assembly top support structure(s) 140 are formed in the cover 40. A flat cover plate 45, dimensioned to fit into a cover shoulder 47, is attached to the cover 40, for example, by welding. The reinforcing cover support web 42 provides the cover 40 with enhanced strength characteristics, allowing the flat cover plate 45 to have the same thickness as the filter housing sidewall 30. Because the cover 40 in combination with the flat cover plate 45 has much less material overall compared to the prior thick flat plate, total weight and materials costs are reduced. Also, any required machining and or welding operations, for example to attach the cover swing handle 65 and vent port 185 are simplified, because they can be performed upon the substantially reduced thickness of flat cover plate 45. Compared to prior domed covers, a cost advantage for the cover 40 increases with increasing filter housing assembly 20 diameter.

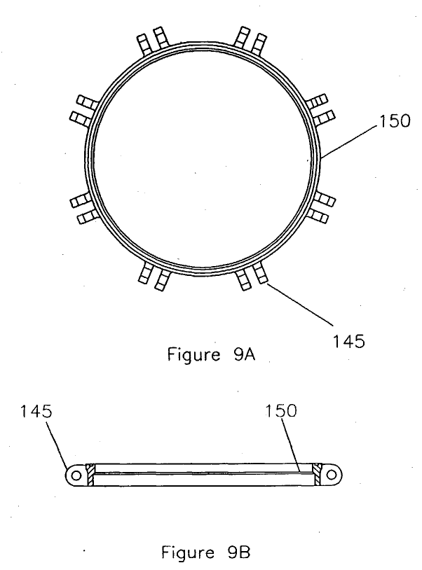

The cover 40 seals against a collar 150, as shown in FIGS. 9A and 9B. The collar 150 is connected, for example by welding, to the top edge of the filter housing sidewall 30. Also, the collar 150 may include a plurality of eyebolt assembly bottom support structure(s) 145 arranged to correspond to the locations of the eyebolt assembly top support structure(s) 140 of the cover 40. Because the eye bolt assembly top structure 140 and eyebolt assembly bottom structure 145 may be formed integrally with the cover 40 and the collar 150, respectively, separate, for example, welding operations to connect each of them independently are eliminated.

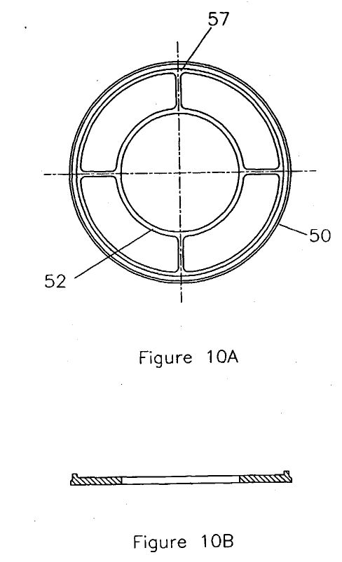

The bottom 50, as shown in FIGS. 10A and 10B has a bottom support web 52 similar in design and function to the cover support web 42. Also similar to the cover shoulder 47, a bottom shoulder 57 is arranged to receive a flat bottom plate 55 that is, for example, welded to the bottom 50.

In addition to withstanding the operating pressure, the bottom 50 also carries the weight of any process fluids within the filter housing assembly 20. The bottom 50 is strengthened by a support leg 170 located proximate the center of the cover. The support leg 170 may be formed from one or more pieces of angled, square or tubular material. As the diameter of the filter housing assembly 20 increases, multiple support leg(s) 170 may be used. Similar to the legs 75, feet may also be attached to the support leg(s) 170.

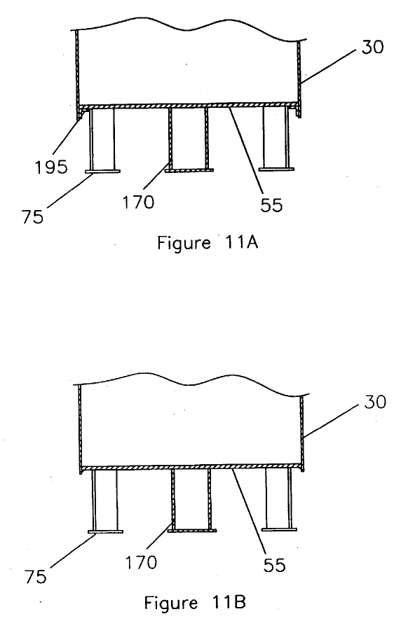

The support leg 170 significantly increases the strength of the filter housing assembly 20. In alternative embodiments, the support leg 170 allows the replacement of the bottom 50 with simplified structure. As shown in FIG. 11A, depending upon the dimensions and process requirements of the filter housing assembly 20, the bottom 50 may be replaced with a flat bottom support ring 195, formed for example from angle material bent into a circle and welded to itself. If pressure requirements are low, a flat bottom plate 55, with a support leg 170, may be welded to the filter housing sidewall 30 without further reinforcement, as shown in FIG. 11B.

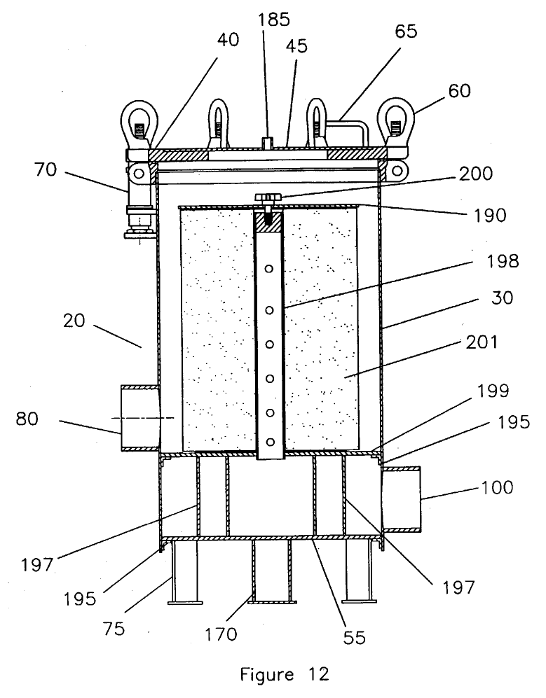

The flat bottom support ring 195 may also be used, for example, to support an internal support plate 199, which may also be reinforced by one or more interior support legs 197. As shown in FIG. 12, this configuration may be used, for example, where the filter is a filter cartridge 201 mounted onto a perforated center support 198 by a retaining nut 200 that secures the filter cartridge 201 between the internal support plate 199 and a cartridge retaining member 190. Process flow entering the inlet 80 is forced through the filter cartridge 201 to the perforated center support 198 which is coupled, through the internal support plate 199, to the outlet 100. Alternatively, multiple filter cartridge(s) may be located either stacked upon each other or each upon a separate perforated center support 198.

To manufacture a filter housing assembly 20 according to the present invention, appropriate cover 40, collar 150 and bottom 50 are fabricated, for example, by casting. These castings may be economically outsourced to third parties specializing in metal casting production. However, one skilled in the art will appreciate that the invention is not limited to castings. Other methods of forming the cover 40, collar 150 and bottom 50, for example welding, machining and or cutting may be used. Appropriately dimensioned pieces of material having any necessary openings for process connections are then, for example, welded to the cover 40, and bottom 50. The filter housing sidewall 30 may be fabricated by rolling a single sheet of material into a cylindrical form that is then welded to itself to form a tube having the desired filter housing assembly 20 diameter. The tube then has the collar 150, for example, welded to a top end and the bottom 50, flat bottom support ring 195, and or flat bottom plate 55 is, for example, welded to a bottom end. Desired legs 75, bottom support leg(s) 170, support plate 90, process connections and/or feed pipe 120 may also be added by, for example, welding. The remainder of the filter housing assembly 20, for example, filters and/or filter baskets 10, pivot assembly 70 and eyebolts 60 may be hand assembled.

One skilled in the art will appreciate that the present invention enables manufacture of pressurizable filter housings 20 with a reduction of required manufacturing operations and or components/raw materials costs. Also, the present invention provides a means for creating large diameter filter housings 20 without use of expensive domed tops and or bottoms or difficult to machine and manipulate thick plate material.

Table of Parts

| | |
|---|---|
| 10 | filter basket |
| 20 | filter housing assembly |
| 30 | filter housing sidewall |
| 40 | cover |
| 42 | cover support web |
| 45 | flat cover plate |
| 50 | bottom |
| 52 | bottom support web |
| 55 | flat bottom plate |
| 60 | eyebolt assembly |
| 65 | cover swing handle |
| 70 | pivot assembly |
| 75 | legs |
| 80 | inlet |
| 90 | basket support plate |
| 100 | outlet |
| 110 | drain port |
| 120 | inlet riser |
| 140 | eye bolt assembly top support structure |
| 145 | eye bolt assembly bottom support structure |
| 150 | collar |
| 170 | flat bottom support leg |
| 185 | vent port |
| 190 | cartridge retaining member |
| 195 | flat bottom support ring |
| 197 | internal support leg |
| 199 | interior baffle |
| 200 | retaining nut |
| 201 | filter cartridge |

Where in the foregoing description reference has been made to ratios, integers, materials, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

1. A liquid filter housing, comprising:
an enclosure having a sidewall, a bottom and an open top;
an inlet and an outlet communicating with an interior of the enclosure to opposite sides of a filter media;
a cover adapted to close the open top;
a plurality of legs connected to the sidewall and extending below the bottom; and
the bottom is a flat plate coupled to a first support structure.

2. The apparatus of claim 1, further including at least one support leg attached to the bottom; the support leg extending below the bottom.

3. The apparatus of claim 1, wherein the cover is a flat plate coupled to a second reinforcing support structure.

4. The apparatus of claim 1, wherein the inlet and the outlet are connected to the enclosure at the bottom.

5. The apparatus of claim 5, wherein the inlet is coupled to an inlet riser that extends above a basket support plate located within the filter housing.

6. The apparatus of claim 1, further including a collar coupled to the sidewall at a top edge.

7. The apparatus of claim 6, wherein the collar and the cover have integral fittings adapted to support a plurality of eyebolts operable to retain the cover against the collar.

8. The apparatus of claim 1, wherein the first support structure is a casting.

9. The apparatus of claim 1, wherein the flat plate has a first thickness and the sidewall has a second thickness; and
the first thickness is less than or equal to the second thickness.

10. The apparatus of claim 1, wherein the first support structure has an outer ring and an inner ring; and
the inner ring and the outer ring are interconnected by a plurality of ribs.

11. The apparatus of claim 0.1, wherein the first support structure is a flat bottom support ring formed from angled material formed into a circle and joined to itself.

12. The apparatus of claim 1, wherein the enclosure has a diameter of at least 12 inches.

13. The apparatus of claim 1, wherein the enclosure has a diameter of at least 24 inches.

14. The apparatus of claim 1, wherein the enclosure has a diameter of at least 36 inches.

15. The apparatus of claim 1, wherein the enclosure has a diameter of at least 48 inches.

16. The apparatus of claim 1, further including a pivot assembly coupled to the cover and the enclosure;
the pivot assembly operable to support the cover as it is pivoted to uncover the open end of the enclosure.

17. The apparatus of claim 1, further including a basket support plate located within the enclosure.

18. A liquid filter housing, comprising:
an enclosure having a sidewall, a bottom and an open top;
an inlet and an outlet communicating with an interior of the enclosure;
a cover adapted to close the open top;
a plurality of legs connected to the sidewall and extending below the bottom; and
a support leg connected to the bottom and extending below the bottom.

19. The apparatus of claim 18, further including a flat bottom support ring connected to the sidewall and the bottom.

20. The apparatus of claim 18, further including an interior baffle supported by an internal support leg;
the interior baffle supporting a perforated center support adapted to receive a filter cartridge.

21. A method for manufacturing a filter housing, comprising the steps of:
forming a first support structure by metal casting;
forming a bottom by welding the support structure to a flat plate;
forming a sidewall tube by bending a portion of material and welding the ends to each other;
welding the bottom to a first end of the sidewall tube;
welding an inlet and an outlet to one of the sidewall tube and the bottom; and
welding a plurality of legs to the sidewall tube.

22. The method of claim 21, further including the steps of
forming a second support structure and a collar by metal casting;
forming a cover by welding the second support structure to a second flat plate,
welding the collar to a second end of the sidewall tube;
attaching a plurality of eye bolts to a plurality of eyebolt assembly bottom support structure formed integral with the collar; and
detachably coupling the cover to the collar via a plurality of eyebolt assembly top support structure formed integral with the second support structure.

23. A liquid filter housing, comprising:
a cylindrical side wall with a top edge and a bottom edge;
a collar with a plurality of eye bolt assembly bottom support structures located on an outside edge of the collar;
the collar welded to the top edge;
a bottom formed from a first support structure welded to a first flat plate;
the bottom welded to the bottom edge;
a plurality of legs welded to the side wall dimensioned to extend below the bottom;
a support member welded to the bottom; the support member dimensioned to extend below the bottom;
a cover formed from a second support structure welded to a second flat plate;
the cover detachably coupled to the collar by a plurality of eyebolt assemblies attached to the plurality of eye bolt assembly bottom support structure.
